(19) United States
(12) Patent Application Publication
(10) Pub. No.: US 2018/0165368 A1
(43) Pub. Date: Jun. 14, 2018

(54) Demographic Based Collaborative Filtering for New Users

(71) Applicant: Google Inc., Mountain View, CA (US)

(72) Inventors: Hari Sasidharan, Bangalore (IN); Harish Chandran, Sunnyvale, CA (US)

(21) Appl. No.: 15/406,378

(22) Filed: Jan. 13, 2017

Related U.S. Application Data
(60) Provisional application No. 62/497,946, filed on Dec. 8, 2016.

(51) Int. Cl. G06F 17/30

(52) U.S. Cl. CPC G06F 17/30867

(57) ABSTRACT

A system and method for generating a stream of content for a new user is described. The method includes determining one or more demographic profiles, each demographic profile being based on content provided by a content database over the computer network to a predetermined set of users that have a common demographic property, the content interacted with by the predetermined set of users, each demographic profile being associated with the common demographic property; determining a first demographic property for a new user; selecting from the one or more demographic profiles, a demographic profile based on the first demographic property of the new user; based on the selected demographic profile, creating a query to the content database; submitting the query over the computer network to the content database; and retrieving content from the content database based on the query, and providing the content to the user.

### CROSS-REFERENCE TO RELATED APPLICATIONS

The present application claims priority, under 35 U.S.C. § 119(e), to U.S. Provisional Patent Application No. 62/497,946, filed Dec. 8, 2016, entitled “Demographic Based Collaborative Filtering for New Users,” which is incorporated by reference in its entirety.

### BACKGROUND

In recent years, there has been widespread proliferation of different applications for sharing content and messaging. For example, there are now social networking applications, news service applications, video sharing applications, and various other applications where content is provided or recommended to the user. Furthermore, additional functionality is constantly being added to these applications to increase user interaction with these applications. Many of these applications are also accessible via a user's mobile phone.

However, one problem for these applications is that for many users, especially new users, the added complexity of such additional functionality makes it difficult for users to interact with the applications and get the content in which they are most interested.

There have been attempts to solve this problem by allowing the user to subscribe to sources or make recommendations based on the user's interests. For example, interest profiles have been generated by observing the topics on which the user is engaging. However, for new users, they have not subscribed to any sources and their interest profile is empty because they have not interacted with the application. This makes it difficult to provide any meaningful recommendations of content.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This specification relates to systems and methods for generating a demographic profile and using it to recommend content. According to one aspect of the subject matter described in this disclosure, a system includes a processor, and a memory storing instructions that, when executed, cause the system to perform operations comprising: determining one or more demographic profiles, each demographic profile being based on content provided by a content database over the computer network to a predetermined set of users that have a common demographic property, the content interacted with by the predetermined set of users, each demographic profile being associated with the common demographic property, determining a first demographic property for a new user, selecting from the one or more demographic profiles, a demographic profile based on the first demographic property of the new user, based on the selected demographic profile, creating a query to the content database, submitting the query over the computer network to the content database, and retrieving content from the content database based on the query, and providing the content to the user.

In general, another aspect of the subject matter described in this disclosure includes a method that includes determining one or more demographic profiles, each demographic profile being based on content provided by a content database over the computer network to a predetermined set of users that have a common demographic property, the content interacted with by the predetermined set of users, each demographic profile being associated with the common demographic property, determining a first demographic property for a new user, selecting from the one or more demographic profiles, a demographic profile based on the first demographic property of the new user, based on the selected demographic profile, creating a query to the content database, submitting the query over the computer network to the content database, and retrieving content from the content database based on the query, and providing the content to the user.

Other implementations of one or more of these aspects include corresponding systems, apparatus, and computer programs, configured to perform the actions of the methods, encoded on computer storage devices.

These and other implementations may each optionally include one or more of the following features. For instance, each of the one or more demographic profiles is determined based on content interacted with by the predetermined set of users that have the common demographic property within a first predetermined period of time, and the method further comprises: updating the one or more demographic profiles based on content interacted with by the predetermined set of users that have the common demographic property within a second predetermined period of time. For example, the predetermined set of users may include a predetermined number of users that have performed one or more from the group of subscribing to a predetermined number of content sources, and reading a number of content items that satisfies a threshold. For instance, features may include wherein the common demographic property includes information about one or more of location, age and gender, wherein each of the one or more demographic profiles includes one or more categories which are determined from the content items interacted with by the respective predetermined set of users, or wherein the one or more categories are weighted according to a score of each of the content items from which the respective categories are determined, and wherein the score is preferably based on one or more of a frequency of reads by the predetermined set of users, a frequency of reads by all users, a number of reshares of the content items of a social network platform, a number of endorsements of the content items, a number of self-posts of the content items; and a number of trending popular content items. In general, another aspect of the subject matter of this disclosure may be embodied in methods wherein the weighting of a category in a demographic profile is increased in importance if the content items have a first score for the predetermined set of users that is relatively high compared to a second score scores for all users.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram of an example system for recommending content.

FIG. 2 is a block diagram illustrating an example system for recommending content as a social network server.

FIG. 3 is a block diagram illustrating an example content recommendation unit.

FIG. 4 is a flowchart illustrating an example method for generating a profile.

FIGS. 5A and 5B are a flowchart illustrating another example method for generating a profile.

FIG. 6 is a flowchart illustrating an example method for recommending content using a demographic profile.

### DETAILED DESCRIPTION

One technical issue with existing applications that recommend content to a user is that providing inappropriate recommendations, cause resource inefficiency when distributing recommendations and/or content from content sources to users using a stream. The inefficiency arises either because a user is provided proactively with content that the user would have otherwise not requested, or because a user requests, based on recommendations received by the user, contents that appears to be of interest but which is in fact not of interest to the user. Hence the systems and methods disclosed herein address the technical issue to reduce said resource inefficiency, in part by increasing the prediction accuracy of selecting content and/or recommendations provided to a user via a stream. The systems and methods disclosed in this specification solve these technical issues by generating one or more demographic profiles, determining a demographic profile, and then using that determined demographic profile to retrieve content items for the user which has the effect of increasing the probability that the query retrieves content items that are used and engaged with by the user so that as few superfluous data as possible is transmitted from a content source to a user when distributing the content items. A demographic profile includes information that enables selection of content items from a content stream based on said information. For example, a demographic profile may specify one or more topics and/or categories of content items. A demographic profile corresponds to a demography which reflects certain demographic properties of users belonging to the demography, the demographic properties being for example a location, age, etc. as described elsewhere herein. A user has certain demographic properties according to which a demographic profile can be chosen. Such demographic profile reflects interests and topics in the specific demography to which the user belongs.

Another technical issue is how to provide recommended content to new users that have not subscribed to any sources or topics and have an empty or near empty interest profile. The systems and methods disclosed in this specification solve this technical issue by identifying healthy or engaged users that are engaged with the system and have a predetermined level of interaction with the system. The system also identifies one or more demographic properties of the healthy or engaged users. With the consent of the healthy or engaged users, the system processes the content items in their stream and their interaction with the content items for healthy or engaged users with a given demographic property, and then uses the processing to build a demographic profile for the given demographic property. The demographic profile is used to recommend content to new users that have the same demographic property. The systems and methods disclosed in this specification are advantageous because they increase the engagement of new users with the system, provide recommended content that more closely matches the user interest, and leverage the interaction and knowledge of existing users that know what they are doing to help new users gain knowledge of the system. Another advantage provided by the systems and methods disclosed in this specification is that, in the context of distributing contents from content sources to users, a smaller, more targeted selection of recommendations and corresponding content items can be provided to each user, so that overall content distribution from news sources to users can be more resource efficient.

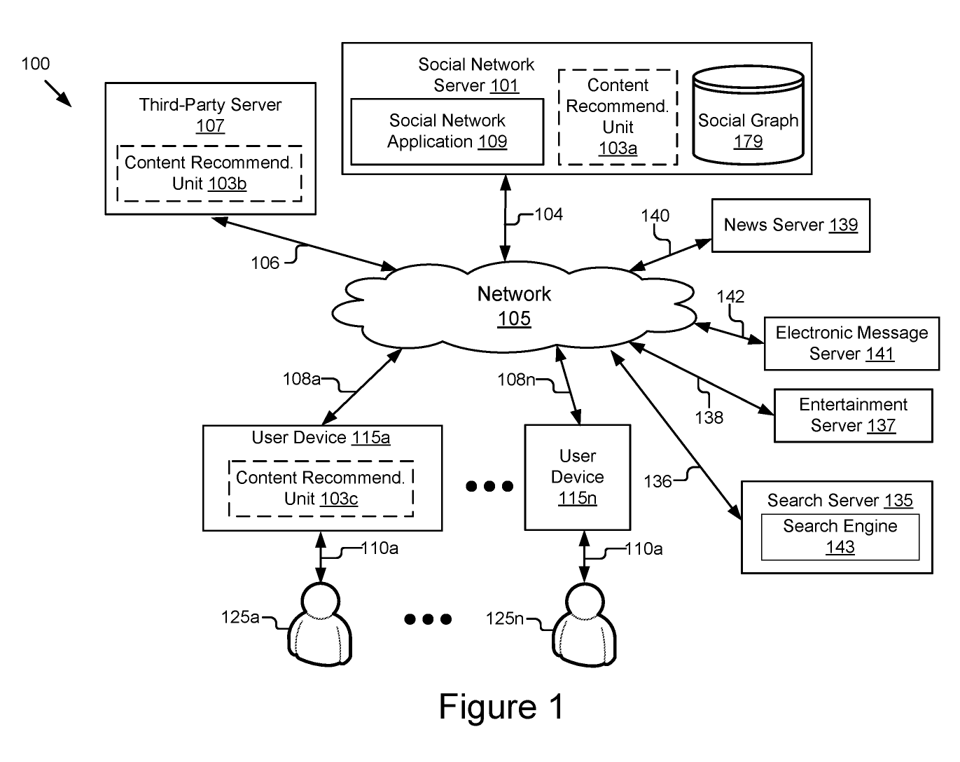

FIG. 1 illustrates a block diagram of an example system 100 for recommending content for display according to some implementations. The system 100 comprises a plurality of computing devices 115a . . . 115n, a social network server 101, a third-party server 107, a search server 135, an entertainment server 137, a news server 139, and an electronic message server 141. The system 100 as illustrated has user (or client) computing devices 115a through 115n typically utilized by users 125a through 125n to access servers hosting applications, websites or services via a network 105. In the illustrated example, these entities are communicatively coupled via the network 105.

It should be recognized that in FIG. 1 as well as other figures used to illustrate the invention, an indication of a letter after a reference number or numeral, for example, “115a” is a specific reference to the element or component that is designated by that particular reference numeral. In the event a reference numeral appears in the text without a letter following it, for example, “115,” it should be recognized that such is a general reference to different implementations of the element or component bearing that general reference numeral.

The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some implementations, the network 105 may be a peer-to-peer network. The network 105 may also be coupled to or includes portions of a telecommunications network for sending data in a variety of different communication protocols. In some other implementations, the network 105 includes Bluetooth communication networks or a cellular communications network for sending and receiving data including via short messaging service (SMS), multimedia messaging service (MMS), hypertext transfer protocol (HTTP), direct data connection, wireless access protocol (WAP), email, etc. In addition, although FIG. 1 illustrates a single network 105 coupled to the computing devices 115 and the servers 101, 107, 135, 137, 139, and 141 in practice one or more networks 105 may be connected to these entities.

The computing devices 115a through 115n in FIG. 1 are used by way of example. Although only two computing devices 115 are illustrated, the disclosure applies to a system architecture having any number of computing devices 115 available to any number of users 125. In the illustrated implementation, the users 125a through 125n interact with the computing device 115a and 115n, via signal lines 110a through 110n, respectively. The computing devices 115a through 115n are communicatively coupled to the network 105 via signal lines 108a through 108n respectively.

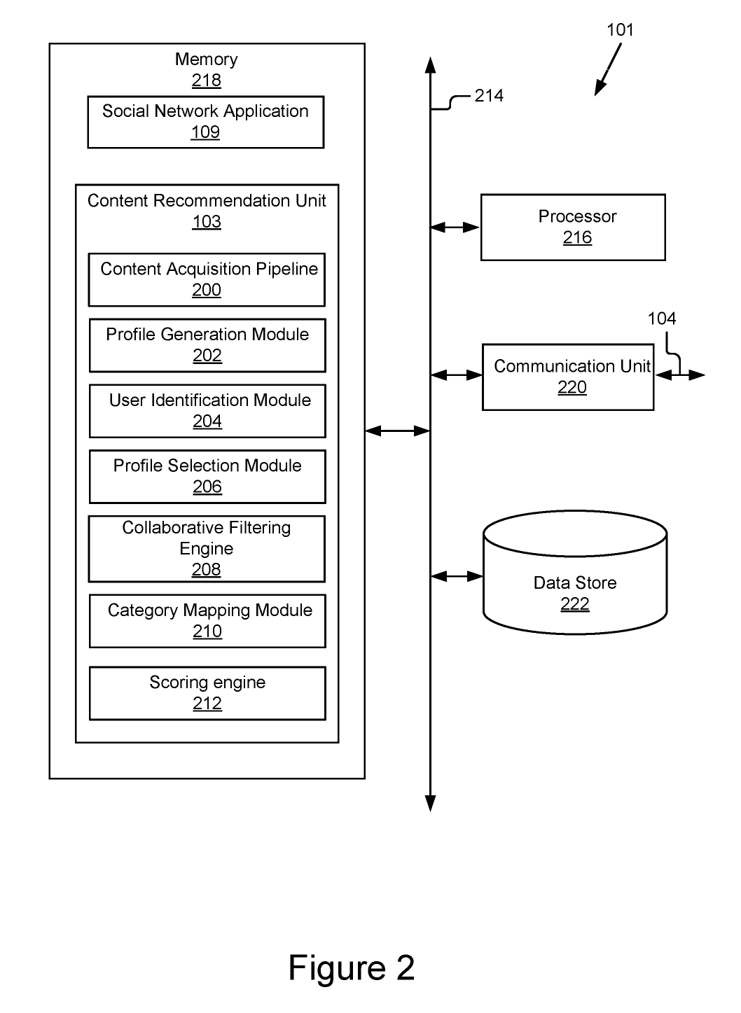

In some implementations, the computing device 115 (any or all of 115a through 115n) can be any computing device that includes a memory and a processor, as described in more detail below with reference to FIG. 2. For example, the computing device 115 can be a laptop computer, a desktop computer, a tablet computer, a mobile telephone, a smart phone, a personal digital assistant, a mobile email device, a portable game player, a portable music player, a television with one or more processors embedded therein or coupled thereto or any other electronic device capable of accessing the network 105, etc.

As depicted in FIG. 1, the content recommendation unit 103a, 103b, 103c is shown in dotted lines to indicate that the operations performed by the content recommendation unit 103a, 103b, 103c as described herein can be performed at the social network server 101, the computing device 115a, 115n, or the third-party server 107, or any combinations of the these components. Additional structure, acts, and/or functionality of the content recommendation unit 103 are described in further detail below with respect to at least FIG. 2. While the content recommendation unit 103 is described below a stand-alone content recommendation unit, in some implementations, the content recommendation unit may be part of other applications in operation on the servers 101, 107, 135, 157, 139 and 141.

In some implementations, the content recommendation unit 103a is operable on the social network server 101, which is coupled to the network 105 via signal line 104. The social network server 101 also includes a social network application 109 and a social graph 179. In some implementations, the content recommendation unit 103a is a component of the social network application 109. Although only one social network server 101 is shown, multiple servers may be present. A social network is any type of social structure where the users are connected by a common feature. The common feature includes friendship, family, work, an interest, etc. The common features are provided by one or more social networking systems, for example those included in the system 100, including explicitly-defined relationships and relationships implied by social connections with other users, where the relationships are defined in a social graph 179. The social graph 179 is a mapping of all users in a social network and how they are related to each other.

In some implementations, the content recommendation unit 103b is stored on and operable on the third-party server 107, which is connected to the network 105 via signal line 106. The third-party server 107 includes, for example, an application that generates a website that includes information generated by the content recommendation unit 103b. For example, the website includes a section of embeddable code for displaying a stream of content generated by the content recommendation unit 103b. Furthermore, while only one third-party server 107 is shown, the system 100 could include one or more third-party servers 107.

In some implementations, the computing devices 115a through 115n include the content recommendation unit 103c. The user 125 (125a through 125n) uses the content recommendation unit 103c to exchange information with the social network server 101, as appropriate to accomplish the operations of the present invention. As one example, the user 125 may have the content recommendation unit 103c operational on the computing device 115 that receives content from the social network server 101, the third-party server 107, the search server 135, the entertainment server 137, the news server 139, and the electronic message server 141. For example, such applications may include social networking applications, messaging applications, photo sharing applications, video conferencing applications, etc. The processing of content for those applications are handled by the content recommendation unit 103c as will be described in more detail below with reference to FIG. 2.

The content recommendation unit 103 receives data and generates a stream of content for a user from heterogeneous data sources. In some implementations, the content recommendation unit 103 receives data from one or more of the third-party server 107, the social network server 101, the user devices 115a . . . 115n, the search server 135 that is coupled to the network 105 via signal line 136, the entertainment server 137 that is coupled to the network 105 via signal line 138, the news server 139 that is coupled to the network 105 via signal line 140, and the electronic message server 141 that is coupled to the network 105 via signal line 142. In some implementations, the search server 135 includes a search engine 143 for retrieving results that match search terms from the Internet.

While the content recommendation unit 103 will be described below in the context of being operation on the social network server 101, it should be understood that the content recommendation unit 103 may alternatively be operable on the third part server 107 or the user devices 115. Similarly, although not shown in FIG. 1 for simplicity and ease of understanding, the content recommendation unit 103 be operable on the search server 135, the entertainment server 137, the news server 139, or the electronic message server 141. Additionally, it should be understood that in some implementations, the components of the content recommendation unit 103 as will be described below with reference to FIG. 2 may be distributed in various arrangements with different components on each of the third part server 107, the user devices 115, the search server 135, the entertainment server 137, the news server 139, or the electronic message server 141.

In some implementations, the content recommendation unit 103 generates one or more demographic profiles, receives candidate content items from heterogeneous data sources, generates a stream of content for the channel from the candidate content items using one of the demographic profiles, and provides the stream of content for one or more channel. In some implementations, the content recommendation unit 103 personalizes the channel for a user by rescoring the candidate content items for a user and generating a personalized content stream by determining a demographic property of the user, selecting a demographic profile corresponding to the demographic property of the user, and using the selected demographic profile to rescoring the candidate content items for the user. In some implementations for rescoring the candidate content items for a user, the content recommendation unit 103 compares the candidate content items to a model. In some implementations, the content recommendation unit 103 updates the model based at least in part on the user's selection and generates an updated content stream according to the updated model.

The search server 135 comprises a processor, a memory, and network communication capabilities. The processor is similar to the processor 216 described below and the memory is similar to the memory 218 described below. In some implementations, the memory stores a search engine 143. The search engine 143 is operable on the processor to receive the query signal and in response return search results. The search engine 143 collects, parses, indexes and stores data to facilitate information retrieval. The search engine 143 also processes search queries and returns search results from the data sources that match the terms in the search query. The search engine 143 also ranks search results based upon relevance to the user. The search engine 143 also formats and sends the search results via the network 105 to the client device 115. In some implementations, the search engine 143 is coupled for communication with the content recommendation unit 103 to provide search results as content items in a stream for a user based on input signals from the content recommendation unit 103.

The entertainment server 137 comprises a processor, a memory, and network communication capabilities. The processor is similar to the processor 216 described below and the memory is similar to the memory 218 described. The entertainment server 137 provides applications and include a user interface allowing a user 115 to interact (e.g., play, pause, view in different formats, endorse, comment on, share, reshare, etc.) with videos, photos, music and other entertaining content. In some implementations, the entertainment server 137 is coupled for communication with the content recommendation unit 103 to provide content and interaction information based on input signals from the content recommendation unit 103.

The news server 139 comprises a processor, a memory, and network communication capabilities. The processor is similar to the processor 216 described below and the memory is similar to the memory 218 described. The news server 139 provides applications and includes a user interface reviewing and interacting (e.g., read, edit, play, pause, view in different formats, endorse, comment on, share, reshare, etc.) with news content. In some implementations, the news servers 139 is coupled for communication with the content recommendation unit 103 to provide content and interaction information based on input signals from the content recommendation unit 103.

The electronic message server 141 may be a computing device that includes a processor, a memory and network communication capabilities. The electronic message server 141 is coupled to the network 105, via a signal line 142. The electronic message server 141 may be configured to send messages to the computing devices 115 (115a through 115n), via the network 105. The electronic message server 141 may also be configured to receive status and other information from the computing devices 115 (115a through 115n), via the network 105. The electronic message server 141 may also be configured to store messages. In some implementations, the messages may include instant messages, email messages, video messages, or text messages in Short Message Service (SMS) format or Multi-Media Message Service (MMS) format. In some implementations, the electronic message server 141 is coupled for communication with the content recommendation unit 103 to provide content and interaction information based on input signals from the content recommendation unit 103.

Referring now to FIG. 2, the content recommendation unit 103 is shown in more detail. FIG. 2 is a block diagram of an example social network server 101, which may be representative of the social network server 101, the computing device 115, or the third-party server 107 having the content recommendation unit 103 operational thereon. As depicted, the social network server 101, may include a processor 216, a memory 218, a communication unit 220, and a data store 222, which may be communicatively coupled by a communication bus 214. The memory 218 may include one or more of the social network application and the content recommendation unit 103.

The processor 216 may execute software, instructions or routines by performing various input, logical, and/or mathematical operations. The processor 216 may have various computing architectures including, for example, a complex instruction set computer (CISC) architecture, a reduced instruction set computer (RISC) architecture, and/or an architecture implementing a combination of instruction sets. The processor 216 may be physical and/or virtual, and may include a single core or plurality of cores (processing units). In some implementations, the processor 216 may be capable of generating and providing electronic display signals to a display device, supporting the display of images, capturing and transmitting images, performing complex tasks including various types of feature extraction and sampling, etc. In some implementations, the processor 216 may be coupled to the memory 218 via the bus 214 to access data and instructions therefrom and store data therein. The bus 214 may couple the processor 216 to the other components of the social network server 101 including, for example, the memory 218, communication unit 220, and the data store 222.

The memory 218 may store and provide access to data to the other components of the social network server 101. In some implementations, the memory 218 may store instructions and/or data that may be executed by the processor 216. The memory 218 is also capable of storing other instructions and data, including, for example, an operating system, hardware drivers, other software applications, databases, etc. The memory 218 may be coupled to the bus 214 for communication with the processor 216, the communication unit 220, the data store 222 or the other components of the social network server 101. The memory 218 may include a non-transitory computer-usable (e.g., readable, writeable, etc.) media, which can be any non-transitory apparatus or device that can contain, store, communicate, propagate or transport instructions, data, computer programs, software, code, routines, etc., for processing by or in connection with the processor 216. In some implementations, the memory 218 may include one or more of volatile memory and non-volatile memory (e.g., RAM, ROM, hard disk, optical disk, etc.). It should be understood that the memory 218 may be a single device or may include multiple types of devices and configurations.

The bus 214 can include a communication bus for transferring data between components of the social network server 101 or between the social network server 101 and other components of the system via the network 105 or portions thereof, a processor mesh, a combination thereof, etc. In some implementations, the content recommendation unit 103 and the social network application 109 may cooperate and communicate via a software communication mechanism implemented in association with the bus 214. The software communication mechanism can include and/or facilitate, for example, inter-process communication, local function or procedure calls, remote procedure calls, network-based communication, secure communication, etc.

The communication unit 220 may include one or more interface devices for wired and wireless connectivity with the network 105 and the other entities and/or components of the system 100 including, for example, the third-party server 107, the computing devices 115, the search server 135, the entertainment server 137, the news server 139, and the electronic messages server 141, etc. For instance, the communication unit 220 may include, but is not limited to, cable interfaces (e.g., CAT-5); wireless transceivers for sending and receiving signals using Wi-Fi™; Bluetooth®, cellular communications, etc.; universal serial bus (USB) interfaces; various combinations thereof; etc. The communication unit 220 may be coupled to the network 105 via the signal line 104. In some implementations, the communication unit 220 can link the processor 216 to the network 105, which may in turn be coupled to other processing systems. The communication unit 220 can provide other connections to the network 105 and to other entities of the system 100 using various standard communication protocols, including, for example, those discussed elsewhere herein.

The data store 222 is an information source for storing and providing access to data. In some implementations, the data store 222 may be coupled to the components 216, 218, 220, 109, or 103 of the social network server 101 via the bus 214 to receive and provide access to data. In some implementations, the data store 222 may store data received from the other entities 107, 115, 135, 137, 139, or 141 of the system 100, and provide data access to these entities. The data store 222 can include one or more non-transitory computer-readable media for storing the data. In some implementations, the data store 222 may be incorporated with the memory 218 or may be distinct therefrom. In some implementations, the data store 222 may include a database management system (DBMS). For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

As depicted in FIG. 2, the memory 218 may include the social network application 109, and the content recommendation unit 103. The content recommendation unit 103 includes a content acquisition pipeline 200, a profile generation module 202, a user identification module 204, a profile selection module 206, a collaborative filtering engine 208, a category mapping module 210, and a scoring engine 212. The components 200, 202, 204, 206, 208, 210, and 212 of the content recommendation unit 103 are coupled for communication with each other and the other components 109, 216, 218, 220, and 222 of the social network server 101 by the bus 214. The components 200, 202, 204, 206, 208, 210, and 212 are also coupled to the network 105 via the communication unit 220 for communication with the other entities 107, 115, 135, 137, 139, or 141 of the system 100.

In some implementations, the content acquisition pipeline 200, the profile generation module 202, the user identification module 204, the profile selection module 206, the collaborative filtering engine 208, the category mapping module 210, and the scoring engine 212 are sets of instructions executable by the processor 216 to provide their respective acts and/or functionality. In other implementations, the content acquisition pipeline 200, the profile generation module 202, the user identification module 204, the profile selection module 206, the collaborative filtering engine 208, the category mapping module 210, and the scoring engine 212 are stored in the memory 218 of the social network server 101 and are accessible and executable by the processor 216 to provide their respective acts and/or functionality. In any of these implementations, the content acquisition pipeline 200, the profile generation module 202, the user identification module 204, the profile selection module 206, the collaborative filtering engine 208, the category mapping module 210, and the scoring engine 212 may be adapted for cooperation and communication with the processor 216 and other components 109, 218, 220, and 222 of the social network server 101.

The content acquisition pipeline 200 may be steps, processes, functionalities or a device including routines for receiving content items from different heterogeneous sources and processing the content items to adds metadata and tags. The content acquisition pipeline 200 also provides the content items to the data store 222 for storage, the scoring server 304 for determining stream content and the profile generation module 202 for generating one or more demographic profiles. The content items and the user information associated with them as described herein are subject to the user consenting to data collection. The content acquisition pipeline 200 is coupled to the heterogeneous data sources (e.g., the search server 135, entertainment server 137, news server 139 and electronic message server 141) to retrieve or receive content items from these sources. In some implementations, the content acquisition pipeline 200 annotates the content items with specific tags, for example for features, types of information, sources, uses, and user activities. Once the content items are annotated, the processing module 202 transmits the data to the data store 222. The data store 222 indexes the features of each content item and stores them in at least one database. The content acquisition pipeline 200 also transmits the content items to the profile generation module 202 so that the content items and the metadata and tags can be used in generating one or more demographic profiles. The content acquisition pipeline 200 also transmits the content items to the scoring server 304 for ranking the content items for a user as will be described below.

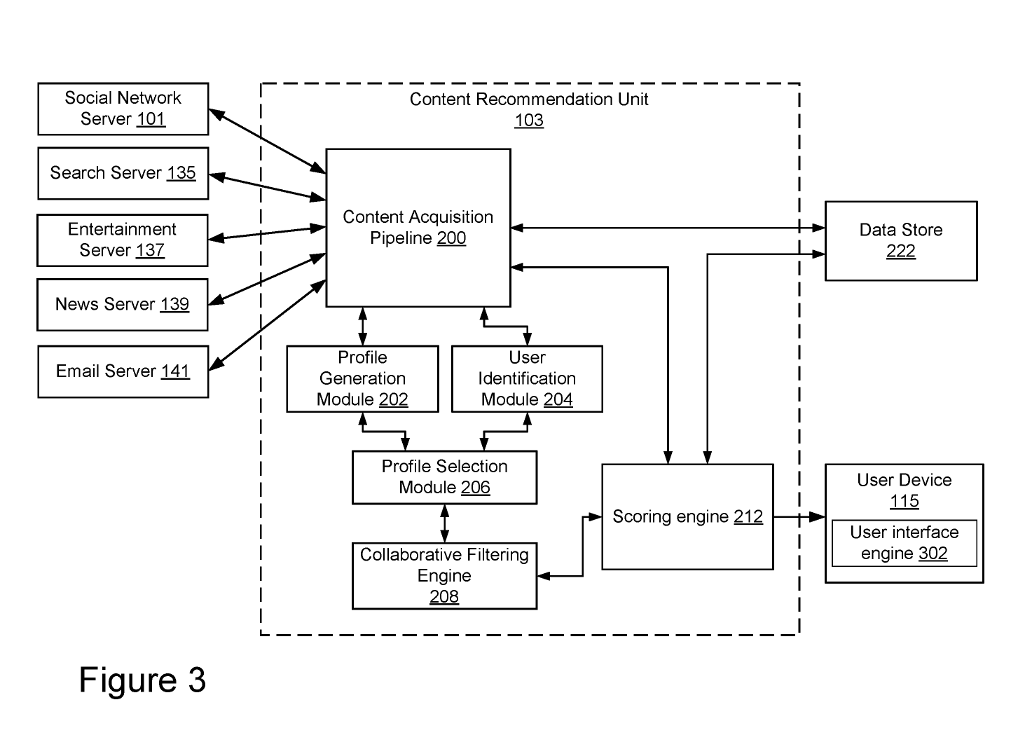

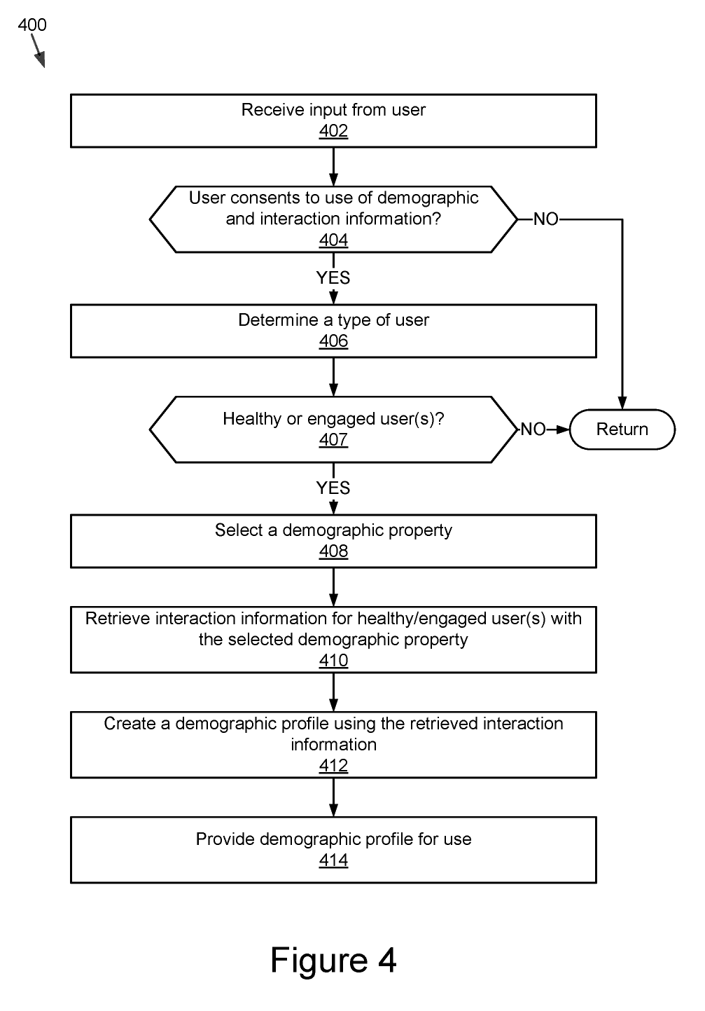

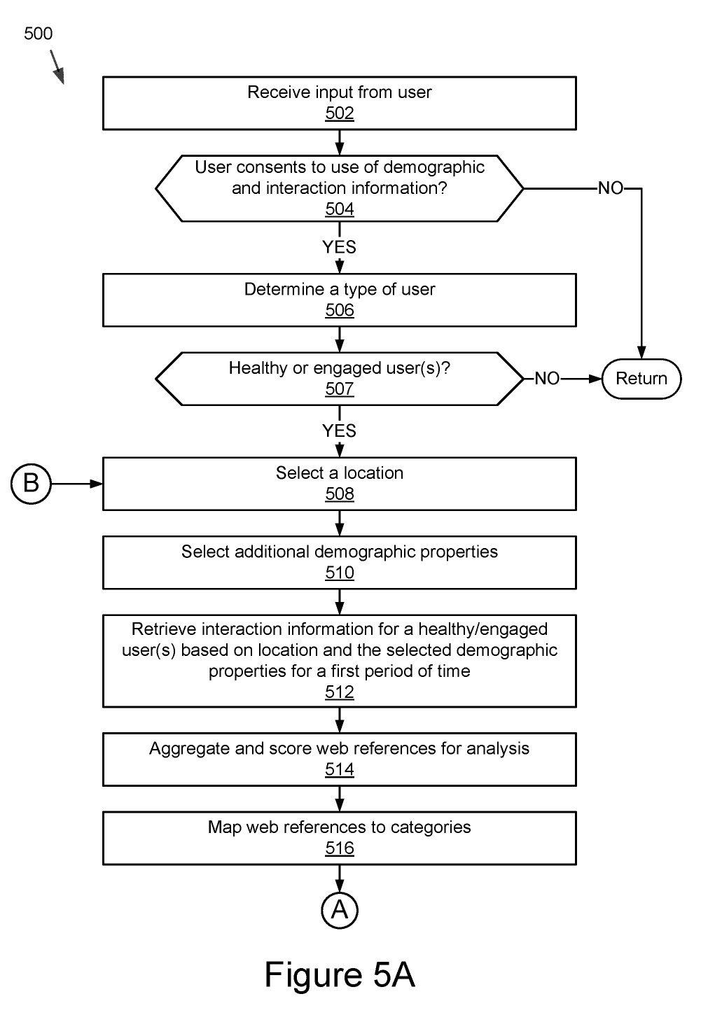

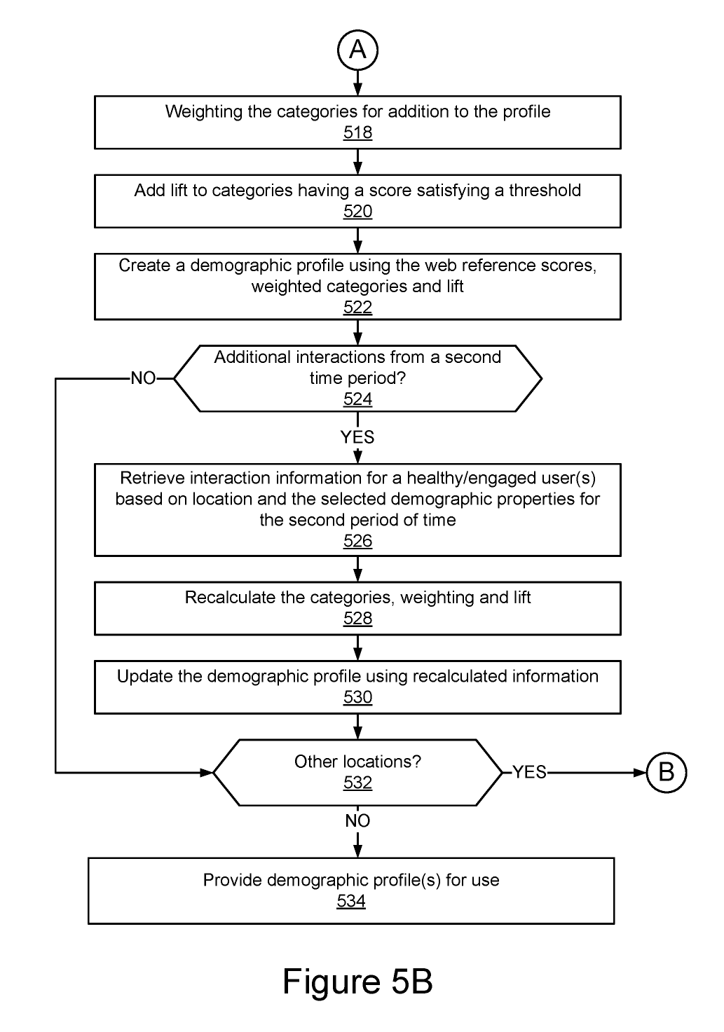

The profile generation module 202 may be steps, processes, functionalities or a device including routines for generating one or more demographic profiles. The profile generation module 202 is coupled to the content acquisition pipeline 200 receive the content items and each content item's metadata and tags. The profile generation module 202 uses this information to generate different demographic profiles as described in more detail below with reference to FIGS. 4, 5A, and 5B. In some implementations, the profile generation module 202 cooperates with the category mapping module 210 (described below) to generate the demographic profiles. In one example, the demographic profile is a table of web reference entities for each country. More specifically, the profile generation module 202 extracts the most common web reference entities (“webrefs”) read by active users in a particular country. Demographic properties includes age, gender, location, occupation, education, employment, marital status, income, children, etc. Each demographic profile created by the profile generation module 202 may be associated with one or more specific demographic properties and a value for that property. For example, the demographic property may be location and the value of the location property may be the United States. In another example, the demographic properties may be location and gender with respective values of Canada and female. It should be understood that any number of demographic profiles may be generated by the profile generation module 202 with different permutations of different demographic properties and different values for those properties. In some implementations, profile generation module 202 generates profiles of healthy users. A healthy user is defined as a user that has interacted with more than a predefined number, h, of content items within a predetermined time period. For example, a healthy user may be users that read more than h (e.g., 100) posts in the last 30 days. The interaction and content items may include: a frequency of reads by the predetermined set of users; a frequency of reads by all users; a number of reshares of content items of a social network platform; a number of endorsements of the content items; a number of self-posts of the content items; a number of trending popular content items, stream for clicks, URL clicks, media plays, expand posts, photo clicks, read, comments/posts, reshares, endorsements, or any other way a user may interact with content items in a stream of content. The interaction information for a predetermined set of healthy users having the same property value for a given demographic property may then be aggregated and weighted to create a demographic profile for that given demographic property. In some implementations, the profile generation module 202 only generates a demographic profile if there are a number of healthy users that satisfy a threshold. For example, in one implementation, a demographic profile for a given demographic property value is only generated if there are at least 100 healthy users, e.g., the threshold is 100 healthy users. Alternatively, the number of healthy user may be at least 50. The profile generation module 202 is also coupled to the collaborative filtering engine 208, as depicted in FIG. 3, to provide the one or more demographic profiles for use in generating the stream of content.

The user identification module 204 may be steps, processes, functionalities or a device including routines for determining a type of the user and identifying one or more properties of the user. The user identification module 204 is coupled to the content acquisition pipeline 200 receive the content items and each content item's metadata and tags. For a selected user and with the user's consent, the user identification module 204 can retrieve the interaction(s) of that user with the content items in the social network server 101. In some implementations, the user identification module 204 can determine the type of the user as one or more of a consumer, an engager, a healthy user or a new user. In some implementations, the user identification module 204 determines whether the selected user is a “new user” by determining whether the selected user satisfies (interacted with fewer than) a threshold number of content items in a predetermined period. For example, users that have read 5 or fewer posts in the last 30 days may be classified as new users. It should be understood that different definitions for a new user may be created and used by modifying the number of interactions or selecting only particular types of interactions with content, for example, only subscription to topic, only reads, only comments, or only selected types of interactions or sets of types of interactions. The user identification module 204 also identifies one or more properties of the user. For example, if location is the demographic property, with user consent, the user identification module 204 may determine the Internet Protocol address (IP address) from which the user is accessing the social network server 101 and then translate the IP address into a location. The location may be a city, a state, a country, a region, etc. in different implementations. In some implementations, with user consent, the user identification module 204 may identify one or more properties of the user by accessing a profile of the user, presenting a question or query to the user, or explicitly or implicitly determining the value of the property for the user based on the property itself or from a knowledge graph. The user identification module 204 is also coupled to the profile selection module 206 to provide a signal indicating whether the user is a new user and one or more demographic properties of the user.

The profile selection module 206 may be steps, processes, functionalities or a device including routines for selecting a demographic profile to use in generating the stream of content for the user. The profile selection module 206 is coupled to the profile generation module 202 to retrieve and access the demographic profiles created by and stored in the profile selection module 206. In some implementation, the profile generation module 202 creates and stores the demographic profiles in the data store 222, then provides an index to the demographic profiles in the data store 222 in response to queries from the profile selection module 206. The profile selection module 206 is also coupled to the user identification module 204 to receive one or more properties for the user for which the stream is being generated. For example, if the property is location, and the user identification module 204 determined the location for the user is Canada, that information (property value=Canada) is provided by the user identification module 204 to the profile selection module 206. The profile selection module 206 uses the property value(s) provided for the user from the user identification module 204 to retrieve the corresponding or matching demographic profile from the profile generation module 202. In some implementations, the user identification module 204 also sends a signal to the profile selection module 206 indicating whether the user is a new user. If the user is not a new user, the profile selection module 206 does not provide a profile to the collaborative filtering engine 208, but rather signals the collaborative filtering engine 208 to use an existing profile of the user. On the other hand, if the user is a new user, then the profile selection module 206 provides the corresponding or matching demographic profile from the profile generation module 202 to the collaborative filtering engine 208. The profile selection module 206 is coupled to the collaborative filtering engine 208 to provide the selected demographic profile.

The collaborative filtering engine 208 may be steps, processes, functionalities or a device including routines for generating a model of user interest based on user input, prior user interactions, or the demographic profile. The collaborative filtering engine 208 is coupled to the profile selection module 206 to receive a demographic profile that it uses to generate the model. The collaborative filtering engine 208 makes automatic predictions (filtering) about the interests of a user based upon the demographic profile which is a collection of preference information from many users (collaborating). In some implementations, the collaborative filtering engine 208 learns a set of topics for a given demographic by observing the topics in the regular posts that appear in the stream for healthy users in that demography and uses that information to fetch a set of posts to show to new users in that demography. More specifically, the collaborative filtering is based upon appearance. For example, this collaborative filtering uses the posts to which the users have subscribed. The use of the posts to which the users have subscribed is advantageous because healthy users know what they are doing with the stream of content and hence the appearance of a post in the stream is a good indication of what they are interested in. The posts being considered may be limited to posts that a healthy users has interacted with recently, e.g. within the past 30 days, and/or that have been posted recently, e.g. within the past 30 days. This has the advantage that the volume of data handled by the collaborative filtering engine for a specific demography can be limited, thus facilitating processing and updating demographic profiles. The collaborative filtering engine 208 is coupled to and transmits a model to the scoring engine 212 periodically or upon request.

The category mapping module 210 may be steps, processes, functionalities or a device including routines for creating categories of content items and determining the mapping of the content items to categories. The category mapping module 210 advantageously provides categories that can be used as input to also determine what content items to provide or how to score the content items. The category mapping module 210 provides input as to which vertical categories are important. To determine which content items are interesting, the category mapping module 210 defines or creates broad categories and determines what content items belong to which categories. Example categories may include sports, music, film, televisions, government, administration, politics, travel, cooking etc. In some implementations, web reference entities (“webref” or “webrefs”) are used to generate the categories. To determine which webref entities are interesting, the category mapping module 210 defines or creates broad categories and determines what webref entities belong to which categories. Some implementations of the disclosure use these webref entities to increase accuracy and minimize ambiguity of information used in online content selection. Web reference entities assist in the understanding of text and augment a repository of knowledge. An entity may be a single person, place or thing, and the repository can include millions of entities that each have a unique identifier to distinguish among multiple entities with similar names (e.g., a Jaguar car versus a jaguar animal). The category mapping module 210 can access a reference entity and scan arbitrary pieces of text (e.g., text in web pages, text of keywords, text of content, text of advertisements) to identify entities from various sources. One such source, for example, may be a list of collections that each webref is a part of. Collections are somewhat broad (like Cricket Bowlers, Actors, etc.), and hence can be associated with one of the categories mentioned above. In case one webref entity belongs to two collections (for instance some athletes have appeared in movies); the category mapping module 210 takes the collection with the highest collection score (representing how tightly the webref is associated with the collection). The category mapping module 210 specifies the mapping from collections to categories. Once, category mapping module 210 has identified the category in an initial check; the category mapping module 210 can continue to evaluate a predicate specified in the config file to confirm that the webref indeed is a member of the category. This advantageously avoids some errors that are present in the collections. It also prevents may-be-problematic webrefs from getting into the demographic profile. The category mapping module 210 is coupled to the content acquisition pipeline 200 to receive metadata about content items and webref entity information. The category mapping module 210 is coupled to the profile generation module 202 to provide the categories so they can be used in creating demographic profiles.

The scoring engine 212 may be steps, processes, functionalities or a device including routines for receiving the demographic profile from the collaborative filtering engine 208 and comparing candidate content items from the content acquisition pipeline 200 to the demographic profile to score them. The scoring engine 212 generates a stream of content for a user based on the scored candidate content items and transmits the stream of content for a user to the user device 115. The scoring engine 212 is coupled to the collaborative filtering engine 208 to receive the demographic profiles for new users. As noted above, the demographic profiles is matched to a demographic property of the user. The scoring engine 212 is coupled to the content acquisition pipeline 200 to receive content items. In some implementations, the scoring engine 212 is coupled to the data store 222 to receive content items.

Referring now to FIG. 3, another example implementation of the content recommendation unit 103 is shown. FIG. 3 shown the general data flow of through the content recommendation unit 103 to produce the stream of content. FIG. 3 illustrates how content items are provided to the content recommendation unit 103, in particular the content acquisition pipeline 200, from different heterogeneous sources of content items. Example heterogeneous sources may include the social network server 101, the third-party server 107, the search server 135, the entertainment server 137, the news server 139, and the electronic message server 141. The heterogeneous data sources (e.g., the search server 135, entertainment server 137, news server 139 and electronic messages server 141) may be crawled by the content acquisition pipeline 200 to retrieve content items and their associated metadata. In some implementations, the heterogeneous data sources transmit the content items and their associated metadata to the content acquisition pipeline 200.

The content acquisition pipeline 200 annotates the content items with specific tags, for example features and a global score that was generated by the scoring engine 212 and processes the data about user activities. The activities described herein are subject to the user consenting to data collection. In some implementations, once the content items are annotated, the content acquisition pipeline 200 transmits the data to the data store 222. The data store 222 indexes the features of each content item and stores them in at least one database. In some implementations, the content items are organized according to an identification format (SourceType#UniqueItemID, for example, “VIDEOSERVICE#video_id” and “NEWS#doc_id”), an item static feature column that holds an item's static features (for example, title, content, content classification, etc.), an item dynamic feature column that holds an item's dynamic features (for example, global_score, number of clicks, number of following, etc.), a source (src) static feature column where the source is a publisher of an item (for example, Newspaper A in news, video uploading in a video service, etc.), a src dynamic feature column holds the source's dynamic features, a content column holds activities that were used to create activities and a scoring_feature holds a message that is used for user scoring.

The content acquisition pipeline 200 also transmits the content items to the scoring engine 212 for a global user ranking. The global scores may be transmitted from the scoring engine 212 to the data store 222, which stores the global scores in association with the content items. The global scores are helpful for organizing the content items in the data store 222.

Turning now to the collaborative filtering engine 208, the collaborative filtering engine 208 receives the demographic profile from the profile selection module 206. The profile generation module 202 generates the demographic profile and provides to the collaborative filtering engine 208 via the profile selection module 202 as has been described above. The demographic profile can be provided to the collaborative filtering engine 208 periodically or upon request.

In some implementations, the scoring engine 212 requests the demographic profile responsive to receiving a request for a stream of content for a user. The scoring engine 212 receives the demographic profile from the collaborative filtering engine 208. The scoring engine 212 requests and receives candidate content items from the content acquisition pipeline 200. In some implementations, the social graph 179 or other information from the social network may be used to filter, rank or provide lift to the candidate content items, and the scoring engine 212 can request and receive candidate content items from people that the user is connected to in the social graph 179. In some implementations, the scoring engine 212 requests and receives candidate content items from the data storage 222. The scoring engine 212 compares the candidate content items to the demographic profile and scores the candidate content items. In the case of candidate content items from the social server 101, the scoring engine 212 receives the candidate content items from the social server 101, compares the candidate content items to the categories in the demographic profile and rescores the candidate content items according to the demographic profile. The scoring engine 212 generates a stream of content for a user based on the scored candidate content items and transmits the stream of content for a user to the user device 115.

The user device 115 includes a user interface engine 302 that receives the stream of content for a user from the scoring engine 212 and displays it in a user interface. In some implementations, the user interface engine 302 generates a widget for display on third-party websites that allows a user to share content. Additionally, the user interface engine 302 provides the user with a user interface for changing the settings and modifying user interests.

### Methods

FIG. 4 is a flowchart illustrating an example method 400 for generating a demographic profile in accordance with the present disclosure. The method 400 begins by presenting a user interface, for example by launching a social network application 109 or other application that presents and recommends content to the user. The user interface may be presented on the computing device 115. Then method 400 receives 402 input from the user requesting a stream of content. In some implementations, the stream of content is automatically generated and provided once the user opens the social network application 109. Then the method 400 determines 404 whether user has consented to use of her demographic and interaction information. If not, the method 400 returns without creating any demographic profiles. However, if the user has consented to use of her demographic and interaction information, the method 400 continues to block 406.

In block 406, the method 400 determines the type of the user, for example using the user identification module 204. For example, the types for users may include one or more of a consumer, an engager, a healthy user, or a new user. The content recommendation unit 103 classifies users as a consumer, an engager, a healthy user, and/or a new user and applies different optimizations to the different segments. For example, consumers are users who do not engage on content items but rather consume content items silently. In some implementations, their stream is weighted with increased importance for clicks: URL clicks, media plays, expand posts, and photo clicks. An engager, for example, is a user that tends to engage on content items, and in some implementations, their stream is weighted with increased importance for endorsements, reshares, and comments. To classify these users, the content recommendation unit 103 processes the engagement rate of the user. For example, a user with an engagement rate>0.001 engagements per read is considered an engager while those with a rate lower than this threshold are considered consumers. In block 406, the content recommendation unit 103 also determines whether the user is a healthy user or a new user. In some implementations, a healthy user is a user that has interacted with more than a predefined number, h, of content items within a predetermined time period; and a new user is a user that interacted with fewer than a threshold number of content items in a predetermined period.

At block 407, the method 400 determines whether the type of the user is a healthy or engaged user. If not, the method 400 returns without creating any demographic profiles. However, if the user is a healthy or engaged user, the method 400 selects 408 a demographic property and a value for that property. For example, location may be used as the demographic property and the value may be Canada. Then the method 400 retrieves 410 interaction information and other metadata for content items of healthy/engaged user(s) with the selected demographic property and which have expressed consent in step 404. For example, this information is retrieved from the content acquisition pipeline 200 or the data store 222 by the profile generation module 202. In some implementations, the method 400 only retrieves 410 interaction information and other metadata only for content healthy users. In some implementations, the content acquisition pipeline 200 retrieves content items from multiple sources in parallel. For example, the multiple sources may include five different sources: 1) self-posts that the viewer of the stream has just made that have not been indexed yet; 2) endorsements—these are posts that point out that a user that the viewer is following has performed an activity; 3) recommendation posts that are served to the user based on a user interest model aggregated from multiple sources; 4) currently trending posts; 5) inferred graph posts which are posts from users in viewer's inferred graph; and 6) regular posts from users, communities and collections that the viewer is following. In one example, the content acquisition pipeline 200 provides the activity ids that are seen by a user which can be used to identify webref entities corresponding to the posts seen by the user. This information when aggregated across a demography is used to identify the popular webref entities.

At block 412, the method 400 creates a demographic profile using the retrieved interaction information of block 410. For example, the method 400 identifies a set of topics of the regular posts that appear in the stream for healthy users that have a matching demographic property and matching value to the property and value selected in block 408. These topics with weights are included in the demographic profile. The demographic profile may also include one or more categories and an indication of their importance. The categories may be provided based on the selected demographic property from the category mapping module 210. Once created, the method 400 provides, in step 414, the demographic profile for use in generating a stream of content for the user. It should be understood that process of FIG. 4 may be performed repeatedly for different properties and different values of the properties, and for different users.

FIGS. 5A and 5B show another example method 500 for generating a demographic profile. FIGS. 5A and 5B are provided to illustrate that the demographic profiles may be: 1) based on a plurality of demographic properties with different values, 2) updated periodically; 3) based on webrefs and categories. The method 500 begins by receiving 502 input from the user requesting a stream of content and determining 504 whether user has consented to use of her demographic and interaction information. If the user has not consented to use of her demographic and interaction information, the method 500 returns without creating any demographic profiles. On the other hand, if the user has consented to use of her demographic and interaction information, the method 500 proceeds to block 506 and determines the type of the user. And at block 507, the method 500 determines whether the type of the user is a healthy or engaged user. If not, the method 500 returns without creating any demographic profiles. However, if the user is a healthy or engaged user, the method 500 continues in block 508. These steps 502, 504, 506, and 507 are similar to the steps 402, 404, 406, and 407 described above with reference to FIG. 4.

The method 500 continues by selecting 508 a location and a value for the location. The location is a first property used in generating the demographic profile. While the location is and has been described as being a country, it should be understood that is could be a state, province, city, or any other geographic region. As an example, the country could be Canada. The method 500 continues by selecting 510 one or more additional demographic properties and associated values. For example, the additional demographic properties of gender and age may be selected with respective values of male and 18-25 years old. Then the method 500 retrieves 512 interaction information and other metadata for content items of healthy/engaged user(s) based on the location and the selected demographic properties, and which have expressed consent in step 504. In some implementations, block 512 retrieves interaction information and other metadata for content items of the healthy user typed in block 506. In some implementations, block 512 retrieves interaction information and other metadata for content items of the healthy user(s) that have matching location and demographic properties as the user typed in block 506. The interaction information and other metadata for content items is also limited to those interactions that occurred within a first time period. Continuing the above example, in block 512 this would result in retrieval of interaction information and other metadata for content items of healthy users accessed from Canada by males 18-25 years old for a predetermined time period of one week. This provides the base data set from which the demographic profile may be created.

The method 500 continues by aggregating 514 and scoring web references corresponding to the content items for analysis. In some implementations, the score assigned for each webref entity for a demography=Σ log (per-user-count+1). The summation is done across a predetermined set of users of the demography. The individual contribution of a user is natural-log (times-user-has-seen-the-webref+). The aggregated webrefs entities are output into a table for later analysis. Then the method 500 also maps 516 the web references to categories. This can be performed by the category mapping module 210 as described above. The aggregated webrefs entities are not directly used because they contain a lot of very generic webref entities that are too generic to be differentiating. For example, every video service video embedded post will contain the webrefs of the name of the video service and “Video.” Thus, these webrefs will occur in every demographic and add very little value to understanding of the interests of users in that demographic. Next, the method 500 weights 518 the categories for addition to the profile. Based on other information about the demographic properties, the some categories may be of weighted as more important because they are of more interest to the user than others. The categories are weighted based on their importance to the demographic properties.

Referring now also to FIG. 5B, the method 500 weights 518 the categories for addition to the profile. Based on other information about the demographic properties, the some categories may be of weighted as more important because they are of more interest to the user than others. The categories are weighted based on their importance to the demographic properties. Next, the method 500 continues by adding 520 lift to categories having a score satisfying a threshold. For example, the method 500 may review the topics, and then re-score or rank the topics using the knowledge graph and interactions by the demography matching the selected demographic properties. Then lift is computed for categories based the rescoring for the demography. The categories that have scores above a threshold are then included in the demographic profile. The addition of this lift may cause some categories to be included and others to be removed from the demographic profile. At block 522, the method 500 creates a demographic profile using the web reference scores, weighted categories and lift.

Next, the method 500 determines 524 whether there are additional interactions from a second time period. If not, the method 500 continues at block 532. If there are additional interactions from a second time period, the method 500 proceeds to block 526. This process illustrates that the demographic profile may be recomputed every hour, day, week, month or year as needed or desired. At block 526, the method 500 retrieves interaction information for a healthy/engaged user based on the selected location and the selected demographic properties for a second period of time. Then method 500 recalculates 528 the categories, weighting and lift similar as was described above with reference to blocks 514, 516, 518 and 520. Then the method 500 updates 530 the demographic profile using recalculated information. Updating has the technical effect that the demographic profile is kept current over time, which means that the profile reflects the most recent content items of the various content sources, and that the profile can be kept at a manageable size. Then method 500 determines 532 whether there are other locations for which to compute a demographic profile. It should be understood that process of FIGS. 5A and 5B may be performed repeatedly for different properties and different values of the properties, and for different users. As an example, multiple demographic profiles for location as the property may be created. For example, there may be one demographic profile for each location value where the location values are different countries such as the United States, Canada, Mexico, China, Japan, Russia, United Kingdom, Germany, France, etc. If so the method 500 returns to block 508 of FIG. 5A and repeats steps 510-530 to create a profile for another location. If there are not additional locations, the method 500 provides 534 the demographic profile for use in generating a stream of content for the user

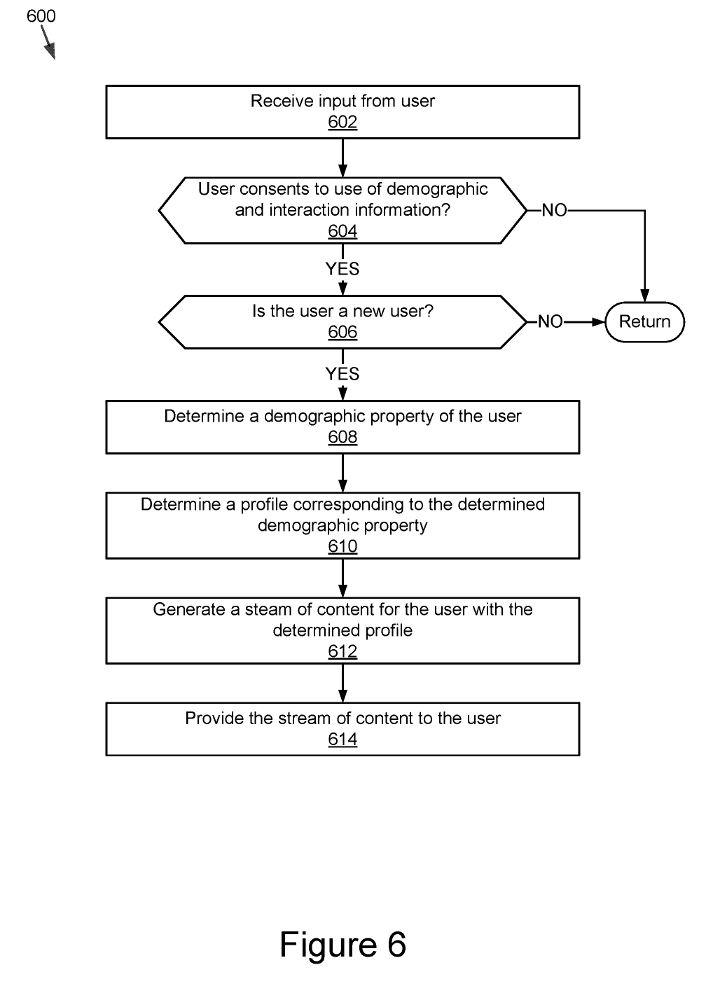

FIG. 6 shows an example method 600 for recommending content using a demographic profile. Then method 600 receives 602 input from the user requesting a stream of content. Then the method 600 determines 604 whether user has consented to use of her demographic and interaction information. If not, the method 600 returns and does not use the demographic profile to create the stream of content and uses other means. However, if the user has consented to use of her demographic and interaction information, the method 600 continues to block 606. In block 606, the method 600 determines whether user is a new user. As noted above, a new user is a user that has had limited interaction with social network 109. For example, the method 600 may determining whether the user has interacted with fewer than a threshold number of content items in a predetermined period. If the user is not a new user, then the method 600 returns and the user's existing profile can be used to generate the stream of content. However, if the user is a new user, then the method 600 determines 608 one or more demographic properties of the user. As an example, the location of the user may be determined by identifying the IP address from which the user is accessing the social network server 101 and then translating the IP address into a location. Next the method 600 determines 610 a demographic profile corresponding to the demographic property determined in block 608. Then the method 600 generates 612 a steam of content for the user with the determined demographic profile. Finally, the stream of content is provided 614 to the user. Specifically, the determined demographic profile is used to fetch a set of content items to show new users. In some implementations, the collaborative filtering engine 208 looks up a corresponding demographic profile, queries the content acquisition pipeline 200 for content items then provide the scoring engine 212 to mix into the stream of content. In some implementations, the demographic profile is a list of topics and new indexing-serving of the content recommendation unit 103 retrieves posts for the given list of topics. Topics can be specified in various vocabulary including webrefs, high-dimensional embedding factors etc. The content recommendation unit 103 may also include indexing, scoring, ranking, diversity and a whole host of topical retrieval issues. The content recommendation unit 103 is particularly advantageous because the use of demographic profiles eliminates the cold start problem for new users that have no historical interest data or an undeveloped interest model. The content recommendation unit 103 also breaks down the feedback loops that make it difficult to recommend interesting content in conventional systems.

In situations in which certain implementations discussed herein may collect or use personal information about users (e.g., user data, information about a user's social network, user's location, user's biometric information, user's activities and demographic information), users are provided with one or more opportunities to control whether the personal information is collected, whether the personal information is stored, whether the personal information is used, and how the information is collected about the user, stored and used. That is, the systems and methods discussed herein collect, store and/or use user personal information only upon receiving explicit authorization from the relevant users to do so. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

Reference in the specification to “some implementations” or “an implementation” means that a particular feature, structure, or characteristic described in connection with the implementation is included in at least some instances of the description. The appearances of the phrase “in some implementations” in various places in the specification are not necessarily all referring to the same implementation.

Some portions of the detailed description are presented in terms of processes and symbolic representations of operations on data bits within a computer memory. These symbolic descriptions and representations are the means used by those skilled in the data processing arts to most effectively convey the substance of their work to others skilled in the art. A process is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may include a general-purpose computer selectively activated or reconfigured by a computer program stored in the computer. Such a computer program may be stored in a non-transitory computer readable storage media, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementations, an entirely software implementation or implementations containing both hardware and software elements. In some implementations, the specification is implemented in software, which includes but is not limited to firmware, resident software, microcode, etc.

Furthermore, the description can take the form of a computer program product accessible from a computer-usable or computer-readable media providing program code for use by or in connection with a computer or any instruction execution system. For the purposes of this description, a computer-usable or computer readable media can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or social network data stores through intervening private or public networks. Modems, cable modem and Ethernet cards are just a few of the currently available types of network adapters.

Finally, the processes and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be implemented in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer implemented method for distributing content over a computer network to a user, the method comprising:
determining one or more demographic profiles, each demographic profile being based on content provided by a content database over the computer network to a predetermined set of users that have a common demographic property, the content interacted with by the predetermined set of users, each demographic profile being associated with the common demographic property;
determining a first demographic property for a new user;
selecting from the one or more demographic profiles, a demographic profile based on the first demographic property of the new user;
based on the selected demographic profile, creating a query to the content database;
submitting the query over the computer network to the content database; and
retrieving content from the content database based on the query, and providing the content to the user.

2. The method of claim 1, wherein each of the one or more demographic profiles is determined based on content interacted with by the predetermined set of users that have the common demographic property within a first predetermined period of time, and the method further comprises:
updating the one or more demographic profiles based on content interacted with by the predetermined set of users that have the common demographic property within a second predetermined period of time.

3. The method of claim 1, wherein the predetermined set of users includes a predetermined number of users that have performed one or more from the group of:
subscribing to a predetermined number of content sources; and
reading a number of content items that satisfies a threshold.

4. The method of claim 1, wherein the common demographic property includes information about one or more of location, age and gender.

5. The method of claim 1, wherein each of the one or more demographic profiles includes one or more categories which are determined from the content items interacted with by the respective predetermined set of users.

6. The method of claim 5, wherein the one or more categories are weighted according to a score of each of the content items from which the respective categories are determined, and wherein the score is preferably based on one or more of:
a frequency of reads by the predetermined set of users;
a frequency of reads by all users;
a number of reshares of the content items of a social network platform;
a number of endorsements of the content items;
a number of self-posts of the content items; and
a number of trending popular content items.

7. The method of claim 6, wherein the weighting of a category in a demographic profile is increased in importance if the content items have a first score for the predetermined set of users that is relatively high compared to a second score scores for all users.

8. A computer program product comprising a non-transitory computer readable medium including a computer readable program, wherein the computer readable program when executed on a computer causes the computer to perform operations comprising:
determining one or more demographic profiles, each demographic profile being based on content provided by a content database over the computer network to a predetermined set of users that have a common demographic property, the content interacted with by the predetermined set of users, each demographic profile being associated with the common demographic property;
determining a first demographic property for a new user;
selecting from the one or more demographic profiles, a demographic profile based on the first demographic property of the new user;
based on the selected demographic profile, creating a query to the content database;
submitting the query over the computer network to the content database; and
retrieving content from the content database based on the query, and providing the content to the user.

9. The computer program product of claim 8, wherein each of the one or more demographic profiles is determined based on content interacted with by the predetermined set of users that have the common demographic property within a first predetermined period of time, and wherein the operations further comprise:
updating the one or more demographic profiles based on content interacted with by the predetermined set of users that have the common demographic property within a second predetermined period of time.

10. The computer program product of claim 8, wherein the predetermined set of users includes a predetermined number of users that have performed one or more from the group of: subscribing to a predetermined number of content sources; and reading a number of content items that satisfies a threshold.

11. The computer program product of claim 8, wherein the common demographic property includes information about one or more of location, age and gender.

12. The computer program product of claim 8, wherein each of the one or more demographic profiles includes one or more categories which are determined from the content items interacted with by the respective predetermined set of users.

13. The computer program product of claim 12, wherein the one or more categories are weighted according to a score of each of the content items from which the respective categories are determined, and wherein the score is preferably based on one or more of:
a frequency of reads by the predetermined set of users;
a frequency of reads by all users;
a number of reshares of the content items of a social network platform;
a number of endorsements of the content items;
a number of self-posts of the content items; and
a number of trending popular content items.

14. The computer program product of claim 13, wherein the weighting of a category in a demographic profile is increased in importance if the content items have a first score for the predetermined set of users that is relatively high compared to a second score scores for all users.

15. A system comprising:
a processor; and
a memory storing instructions that, when executed, cause the system to perform operations comprising:
determining one or more demographic profiles, each demographic profile being based on content provided by a content database over the computer network to a predetermined set of users that have a common demographic property, the content interacted with by the predetermined set of users, each demographic profile being associated with the common demographic property;
determining a first demographic property for a new user;
selecting from the one or more demographic profiles, a demographic profile based on the first demographic property of the new user;
based on the selected demographic profile, creating a query to the content database;
submitting the query over the computer network to the content database; and
retrieving content from the content database based on the query, and providing the content to the user.

16. The system of claim 15, wherein each of the one or more demographic profiles is determined based on content interacted with by the predetermined set of users that have the common demographic property within a first predetermined period of time, and wherein the operations further comprise:
updating the one or more demographic profiles based on content interacted with by the predetermined set of users that have the common demographic property within a second predetermined period of time.

17. The system of claim 15, wherein the predetermined set of users includes a predetermined number of users that have performed one or more from the group of: subscribing to a predetermined number of content sources; and reading a number of content items that satisfies a threshold.

18. The system of claim 15, wherein the common demographic property includes information about one or more of location, age and gender.

19. The system of claim 15, wherein each of the one or more demographic profiles includes one or more categories which are determined from the content items interacted with by the respective predetermined set of users.

20. The system of claim 19, wherein the one or more categories are weighted according to a score of each of the content items from which the respective categories are determined, and wherein the score is preferably based on one or more of:
a frequency of reads by the predetermined set of users;
a frequency of reads by all users;
a number of reshares of the content items of a social network platform;
a number of endorsements of the content items;
a number of self-posts of the content items; and
a number of trending popular content items.

21. The system of claim 20, wherein, wherein the weighting of a category in a demographic profile is increased in importance if the content items have a first score for the predetermined set of users that is relatively high compared to a second score scores for all users.
